(19) United States
(12) Patent Application Publication
(10) Pub. No.: US 2010/0103104 A1
(43) Pub. Date: Apr. 29, 2010

(54) APPARATUS FOR USER INTERFACE BASED ON WEARABLE COMPUTING ENVIRONMENT AND METHOD THEREOF

(75) Inventors: Yongki SON, Daejeon-city (KR); Jeongmook LIM, Daejeon-city (KR); Dongwoo LEE, Daejeon-city (KR); Hyuntae JEONG, Daejeon-city (KR); Ilyeon CHO, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/604,895

(22) Filed: Oct. 23, 2009

(30) Foreign Application Priority Data
Oct. 29, 2008 (KR) 10-2008-0106474
Sep. 23, 2009 (KR) 10-2009-0090147

(51) Int. Cl. G06F 3/033

(52) U.S. Cl. 345/158

(57) ABSTRACT

Provided is an apparatus for user interface based on wearable computing environment includes: a signal measurement unit including a plurality of image measurement units that includes image sensors each of which receives optical signals generated from a position indicator that is worn on user's fingers or near a user's wrist to generate optical signals and measures images of the user foreground; and a signal processor that analyzes each image measured by the signal measurement unit to measure three-dimensional coordinates, recognizes a motion pattern of the user's hand on the three-dimensional coordinates from the optical signals received by the signal measurement unit, and outputs the corresponding instructions.

### RELATED APPLICATIONS

The present application claims priority to Korean Pat ent Application Serial Number 10-2008-106474, filed on Oct. 29, 2008 and Korean Patent Application Serial Number 10-200 9-090147, filed on Sep. 23, 2009, the entirety of which are hereby incorporated by reference.

### BACKGROUND OF THE INVENTION

1. Field of the Invention

The present invention relates to an apparatus for user interface based on wearable computing environment and a method thereof, and in particular, to a user interface based on wearable computing environment and a method thereof capable of using motions of both hands on a three-dimensional space of a user foreground as inputs of a wearable system or peripheral apparatuses while being suitable for wearable computing environment.

2. Description of the Related Art

Efforts to detect the motion of a user in a limited space where existing systems are provided, in particular, the motion of hands and use it as interaction between computers have been frequently made. The existing systems have a disadvantage in that the user wears an apparatus in a glove type or can perform inputs only in limited places where the existing systems are equipped well and are defined.

In addition, apparatuses such as a three-dimensional space mouse or a pen that are currently marketed, measure the motion of the user's hand by using uses a gyro sensor and use it as a user input. In order to use theses apparatuses, the user should grip theses apparatuses. Therefore, it is inconvenient that the user should carry these apparatuses if necessary.

A multi touch, such as Ipod Touch from Apple Co, Surface from Microsoft Co., Jeff Han's Multi-Touch apparatus, applies a touch to a display of an apparatus to maximally exhibit the advantage of a multi touch, but it is inconvenient that the user should grip the apparatus by a hand or should be used in a limited apparatus.

In particular, in the case of the user interface for the wearable system that attaches or carries an apparatus or a computer to and on the user's body, it is designed in consideration of factors, such as mobility that should carry the apparatuses and wearability that can be easily carried on the user's body.

### SUMMARY OF THE INVENTION

In order to solve the above problems, it is an object of the present invention to provide an apparatus for user interface based on wearable computing environment and a method thereof by motions such as a user's hand on a three-dimensional space of a user foreground as inputs of a wearable system or peripheral apparatuses while being suitable for wearable computing environment.

In order to achieve the above object, there is provided an apparatus for user interface based on wearable computing environment according to the present invention, including: a position indicator that is worn near a user's wrist to generate optical signals; a signal measurement unit including a plurality of image measurement units that include image sensors each of which receives the optical signals generated from the position indicator and measures images of the user foreground; and a signal processor that analyzes each image measured by the signal measurement unit to calculate three-dimensional coordinates, recognizes a motion pattern of the user's hand on the three-dimensional coordinates from the optical signals received by the signal measurement unit, and outputs the corresponding instructions.

The signal measurement unit includes a plurality of image measurement unit that includes image sensors and a body shaking measurement unit that measures the body shaking from the motion of the user.

The body shaking measurement unit includes an inertial measurement unit.

The image measurement unit includes a filter that divides the position signals generated from the positional indicator and the images.

The signal processor implements a virtual display screen on an area where view angles of the image sensors, which are provided in the plurality of image measurement units, are overlapped with each other and calculates the three-dimensional coordinates from the images on the virtual display screen.

The signal processor includes a two-dimensional coordinate calculator that extracts the two-dimensional coordinates from each image measured by the plurality of image measurement units, wherein the signal processor calculates the three-dimensional coordinates based on the two-dimensional coordinates extracted by the two-dimensional coordinate calculator and the positional information of the hands sensed by the position signals.

The signal processor further includes a body shaking corrector that corrects the shaking of the images measured from the image measurement unit based on a degree of body shaking measured by the body shaking measurement unit.

The position indicator includes a position signal generator that generates the position signals each time the position of the user's hand moves and an input signal measurement unit that receives control instructions from the user, wherein the position indicator controls the operation of the position signal generator based on the user control instructions input to the input signal measurement unit.

The position signal generator generates the position signals in an optical signal type.

In order to achieve the above object, there is provided a method for user interface based on wearable computing environment according to the present invention, including: receiving position signals generated from a position indicator that is worn near a user's wrist and generates position signals and measuring images of the user foreground; and calculating three-dimensional coordinates from images measured at the measuring; grasping the positions of the user's hands from the position signals received at the measuring, recognizing motion patterns of the user' hands on the calculated three-dimensional coordinates; and outputting instructions corresponding to the motion patterns recognized at the recognizing.

The measuring includes measuring a degree of body shaking from the motion of the user.

The method further includes correcting the shaking of the images measured at the measuring based on the degree of the measured body's shaking.

The measuring implements a virtual display screen on an area where view angles of a plurality of image sensors measuring the images at the measuring are overlapped with each other and calculates the three-dimensional coordinates from the images on the virtual display screen.

The calculating includes extracting the two-dimensional coordinates from each image measured by the plurality of image measurement units and calculates the three-dimensional coordinates based on the extracted two-dimensional coordinates and the positional information of hands sensed by the position signals at the measuring.

The position signals are generated by the position indicator each time the position of the user's hand moves.

The position signals are generated based on the input signals when signals notifying the start and end of the motion of the user's hand are input to the positional indicator from the user.

The position signals are generated in an optical signal type.

When a gesture of both hands is made on the three-dimensional space of the user foreground, the present invention tracks the motion and recognizes and processes the motion in a predetermine pattern, such that it can support the user friendly input interface just like treating objects in the space, in a method of selecting or operating the objects on the user display by supporting the multipoint input functions in the user space in the wearable computing environment using the computer while the user moves.

### BRIEF DESCRIPTION OF THE DRAWINGS

FIGS. 1 and 2 are diagrams referenced for describing an operation of an apparatus for user interface based on wearable computing environment according to the present invention;

FIG. 3 is a block diagram showing a configuration of the motion processor of the apparatus for user interface according to the present invention;

FIG. 4 is a block diagram showing a configuration of a position indicator of the apparatus for user interface according to the present invention;

FIG. 5 is an exemplification diagram referenced for describing a method for measuring images according to the present invention;

FIG. 6 is an exemplification diagram referenced for describing a method for measuring position coordinates according to the present invention; and

FIG. 7 is a flowchart showing an operation flow of the method for user interface according to the present invention.

### DETAILED DESCRIPTION OF THE PREFERRED EMBODIMENTS

Hereinafter, exemplary embodiments of the present invention will be described with reference to the accompanying drawings.

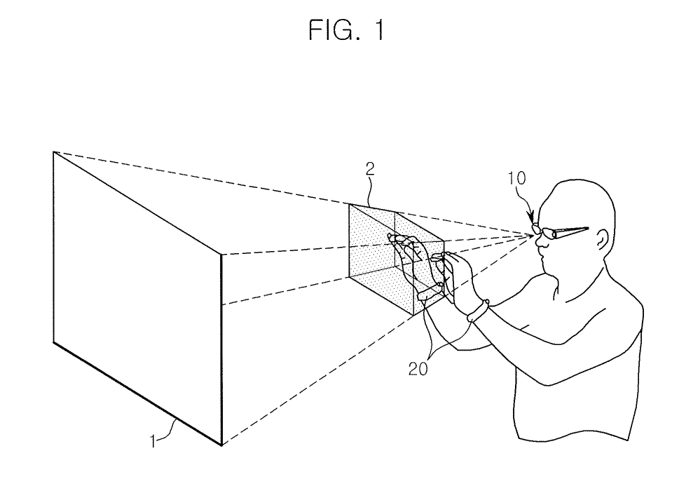

FIGS. 1 and 2 are diagrams referenced for describing an apparatus for user interface based on wearable computing environment according to the present invention.

Referring to FIGS. 1 and 2, the apparatus for user interface based on wearable computing environment according to the present invention includes a position indicator 20 that is mounted near a user's wrist to sense the motion of a hand and a motion processor 10 that recognizes the motion of the hand from the signals sensed by the position indicator 20 and processes the corresponding operations.

First, the user moves his/her hands for controlling a display screen 1 on a virtual display screen 2 rather than on the actual display screen 1 such as a wall face type display apparatus of a wearable computer or a head mounted display (HMD), as shown in FIG. 1.

Herein, the motion of the hand corresponds to all motions that can be displayed by the user, such as letter, symbol, gesture, etc., and corresponds to complex gestures by one hand as well as both hands.

Therefore, the user uses both his/her hands on the virtual display screen 2 and performs an input, such that objects actually output before his/her eyes can be controlled on the three-dimensional space similar to a multi touch. In particular, as shown in FIG. 2, the input can be performed within a predetermined three-dimensional space of the user foreground through a plurality of image measurement units 11a and 11b that are attached to both ends in a glasses type and the corresponding space is determined by view angles from the plurality of image measurement units 11a and 11b.

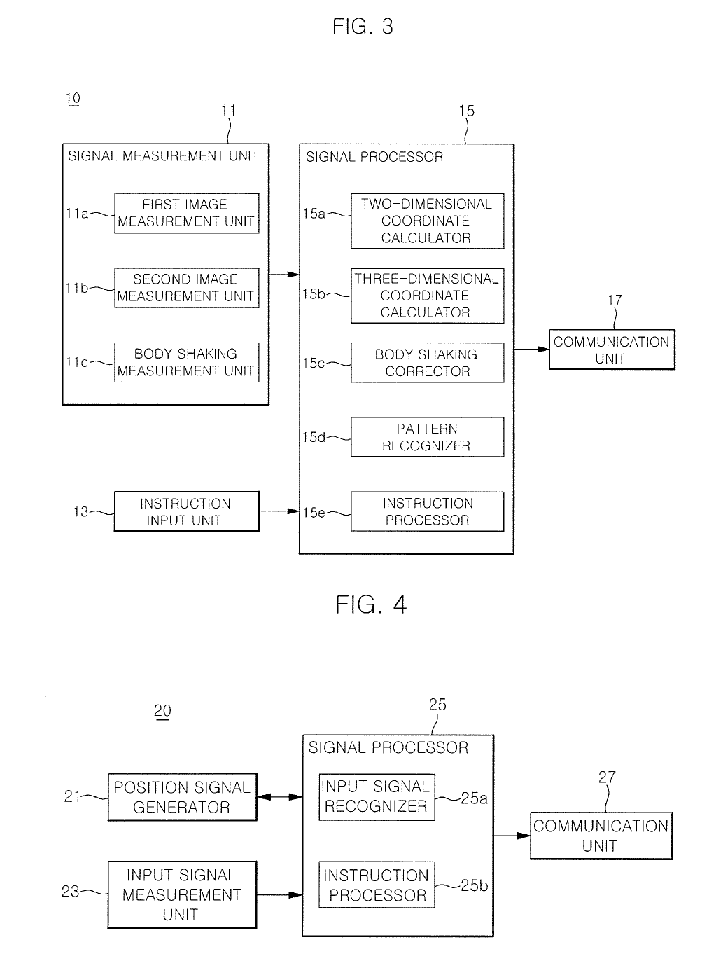

At this time, the position indicator 20 can be provided in plural. The position indicator 20 is implemented as a bracelet type and can be worn on one wrist or both wrists of the user. In addition, the position indicator 20 is implemented as a ring type and can be worn on the user's fingers. Therefore, the embodiment of the present invention describes, by way of example, a case where the position indicator 20 is implemented as a bracelet type and is worn on both wrists of the user, but is not limited thereto. The detailed description of the position indicator 20 will be described with reference to FIG. 4.

Meanwhile, the motion processor 10 is implemented as a wearable type on the user's body similar to the position indicator 20 and can be worn on any part of a body such as glasses, hat, clothes, etc. The embodiment of the present invention describes an example where the motion processor 10 is implemented as glasses, in order to exhibit the same effect as one viewed from the user's vision.

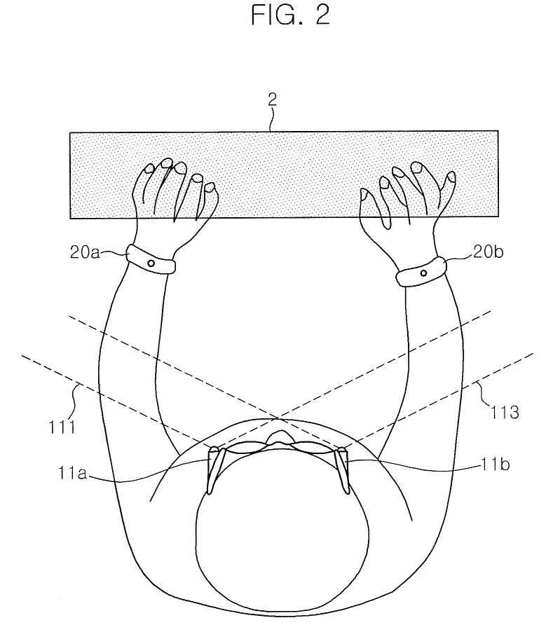

The motion processor 10 includes the plurality of image measurement units 11a and 11b. At this time, each of the plurality of image measurement units 11a and 11b is disposed at different positions and measures signals generated from the position indicator 20 at the corresponding position. The detailed description of the motion processor 10 will be described with reference to FIG. 3.

FIG. 3 is a block diagram showing a configuration of the motion processor 10 according to the present invention.

As shown in FIG. 3, the motion processor 10 according to the present invention includes a measurement unit 11, an instruction input unit 13, a signal processor 15, and a communication unit 17.

In addition, the signal measurement unit 11 includes a first image measurement unit 11a, a second image measurement unit 11b, and a body shaking measurement unit 11c.

The first image measurement unit 11a and the second image measurement unit 11b are disposed at different positions and as shown in FIG. 2, may be disposed at both ends of the glasses. Of course, FIG. 3 shows an example where the first image measurement unit 11a and the second image measurement unit 11b are provided and may further include a third image measurement unit, etc.

At this time, an example where the first image measurement unit 11a and the second image measurement unit 11b are an image sensor that can measure signals generated from the position indicator 20 will be described. It may be one of infrared rays, visible rays, laser, etc., generated from the position indicator 20.

In addition, an example of where the first image measurement unit 11a and the second image measurement unit 11b receive signals generated from the position indicator 20 and senses the position of the user's hand from the received signals will be described. At this time, the first image measurement unit 11a and the second image measurement unit 11b include a physical filter that divides image signals measured by the image sensor and signals received from the position indicator 20.

At this time, examples of the physical filter may include an infrared pass band filter, etc. The infrared pass band filter removes the interference by visible rays, such that the first image measurement unit 11a and the second image measurement unit 11b can more clearly measure infrared signals.

Meanwhile, the body shaking measurement unit 11c measures the degree of the user body shaking. When the body shaking measurement unit 11c measures the motion of the hand, it may further include an inertial measurement unit (IMU) to supplement the generation of error due to the shaking of the user's body. At this time, the body shaking measuring unit 11c transfers the measured signals to the signal processor 15.

The instruction input unit 13 is a unit that receives the control instructions from the user and includes a communication module that receives the control instructions from the motion device.

When the control instructions are input to the position indicator 20 from the user, the position indicator 20 transmits the corresponding instructions to the motion processor 10. Therefore, the instruction input unit 13 receives the control instructions from the position indicator 20 and transmits them to the signal processor 15.

The signal processor 15 includes a two-dimensional coordinate calculator 15a, a three-dimensional calculator 15b, a body shaking corrector 15c, a pattern recognizer 15d, and an instruction processor 15e.

First, the two-dimensional coordinate calculator 15a calculates the two-dimensional coordinates of an area where the position indicator 20 is disposed, that is, an area where hands are positioned, from the images measured by the first image measurement unit 11a and the second image measurement unit 11b. At this time, the two-dimensional coordinate calculator 15a extracts the two-dimensional coordinates of the infrared images that are displayed in a point form in each measured image.

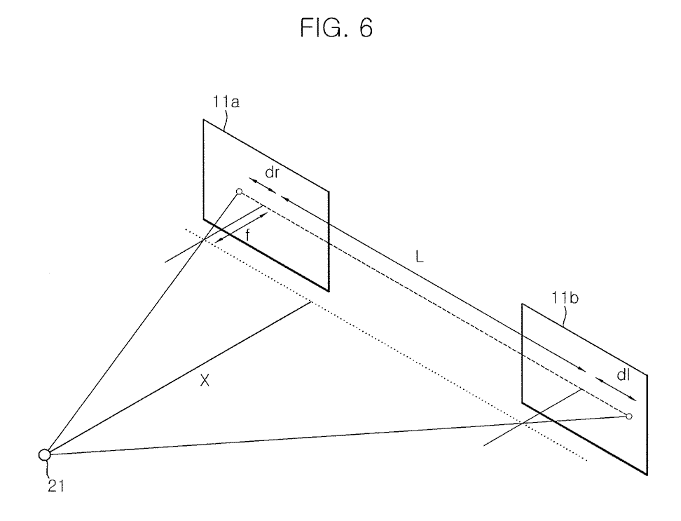

Hereinafter, the three-dimensional coordinate calculator 15b uses the two-dimensional coordinates extracted by the two-dimensional coordinate calculator 15a to calculate the three-dimensional coordinates at the corresponding positions. A model for calculating the three-dimensional coordinates will be described with reference to FIG. 6.

At this time, the first image measurement unit 11a, the second image measurement unit 11b, the two-dimensional coordinate calculator 15a, and the three-dimensional coordinate calculator 15b are implemented as combination, such that they an be implemented as one processor.

The body shaking corrector 15c grasps the degree of the body shaking from the signals measured by the body shaking measurement unit 11c. At this time, the body shaking corrector 15c corrects the body shaking of the images measured by the first image measurement unit 11a and the second image measurement unit 11b based on the grasped information.

The pattern recognizer 15d recognizes the motion patterns in respects to the three-dimensional coordinate calculated by the three-dimensional coordinate calculator 15b from the images corrected by the body shaking corrector 15c.

Thereafter, the instruction processor 15e extracts instructions corresponding to the motion patterns recognized by the pattern recognizer 15d and transmits them to the wearable computer through the communication unit.

The instruction processor 15e is connected to other devices through the wired and wireless communication interface and can transmit the instructions to the corresponding devices.

At this time, the three-dimensional coordinate calculator 15b, the pattern recognizer 15d, and the instruction processor 15e adds the communication interface to the two-dimensional coordinate calculator 15a, such that they can also be processed in other external devices.

Meanwhile, FIG. 4 is a block diagram showing a configuration of the position indicator 20.

Referring to FIG. 4, the position indicator 20 according to the present invention includes a position signal generator 21, an input signal measurement unit 23, a signal processor 25, and a communication unit 27.

The position signal generator 21 is a unit that generates the position signals notifying the current positions of the corresponding position indicator 20. The position signal generator 21 outputs infrared rays, visible rays, laser, etc., in a signal form measurable by the first image measuring unit 11a and the second image measurement unit 11b in the motion processor 10.

The input signal measurement unit 23 is a unit that receives the control instructions from the user. In other words, the user indicates the validity of hand motion that is currently used through the operations such as a click of a mouse that is a computer input device.

At this time, the input signal measurement unit 23 measures a button operation in a ring form, a touch sound of fingers or wrists, electromyogram, etc., to recognize the control instructions from the user.

For example, when the user performs a picking action (tapping action) with his/her thumb finger and index finger in the empty space, the input signal measurement unit 23 analyzes the current operations as effective operations to recognize the start of the motion as the instruction signals. In addition, when there is no user's motion or when the input signal measurement unit 23 will use the electromyogram, it can measure instructions that indicate the start and end of the motion from the fingers catching action and the fingers opening action.

The input signal measurement unit 23 transmits the measured control instructions of the user to the signal processor 25.

The signal processor 25 includes an input signal recognizer 25a and an instruction processor 25b.

The input signal recognizer 25a recognizes the control instructions of the user measured by the input signal measurement unit 23. At this time, the instruction processor 25b transmits the control instructions of the user recognized by the input signal recognizer 25a to the instruction input unit 13 of the motion processor 10 through the communication unit 27.

Meanwhile, the instruction processor 25b outputs predetermined control signals to the position signal generator 21 when it recognizes the instructions notifying the start of the user motion by the input signal recognizer 25a. Therefore, the position signal generator 21 generates the position signals according to the control signals from the instruction processor 25b.

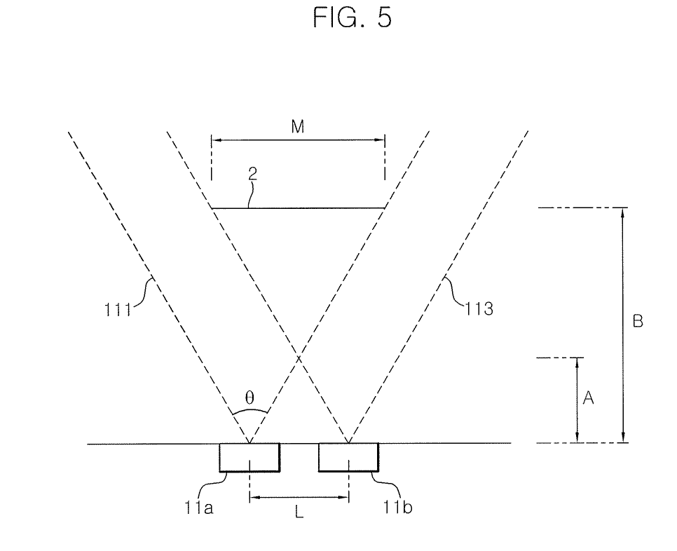

FIG. 5 is an exemplification diagram referenced for describing the operations of the image measurement unit in the motion processor according to the present invention.

As shown in FIG. 5, the first image measurement unit 11a and the second image measurement unit 11b obtain front images. At this time, the view angles of the first image measurement unit 11a and the second image measurement unit 11b determines an area where the virtual display screen 2 is implemented.

In other words, the first image measurement unit 11a and the second image measurement unit 11b have a predetermined view angle (θ) and the virtual display screen 2 is implemented on the area where the view angles of the first image measurement unit 11a and the second image measurement unit 11b are overlapped with each other.

Therefore, the user performs gestures such as actions clenching his/her fist or picking with fingers on the virtual display screen 2 of the three-dimensional space implemented as described above, such that he/she can select objects in the virtual space and moves his/her hands in that state to control a computer such as one moving the corresponding object.

FIG. 6 is an exemplification diagram referenced for describing the operations of a method for calculating coordinates according to the present invention.

Referring to FIG. 6, when the position signals are generated from the position signal generator 21 of the position indicator 20, the first image measurement unit 11a and the second image measurement unit 11b receive the position signals.

At this time, the three-dimensional coordinate calculator 15b calculates the three-dimensional coordinates based on the positions of the position signal generator 21, the first image measurement unit 11a, and the second image measurement unit 11b.

A mode for calculating the three-dimensional coordinates can be obtained using the following [Equation 1].

$$x = \frac{L \cdot f}{dl + dr} \qquad [ Equation 1 ]$$

where dr is a distance from a point where the position signals generated from the position signal generator 21 in the first image measurement unit 11a are reached to the center. d1 is a distance from a point where the position signals generated from the position signal generator 21 in the second image measurement unit 11b are reached to the center.

L is a distance from the center of the first image measurement unit 11a to the center of the second image measurement unit 11b.

f is a distance to a point meeting the position signals generated from the position signal generator 21 in a direction vertical to the first image measurement unit 11a and the second image measurement unit 11b from the centers of the first image measurement unit 11a and the second image measurement unit 11b. In other words, f is a focal distance of the first image measurement unit 11a and the second image measurement unit 11b.

x is a vertical distance from the first image measurement unit 11a and the second image measurement unit 11b to the position signal generator 21.

Therefore, the three-dimensional coordinate calculator 15b calculates the three-dimensional coordinates by using the two-dimensional coordinates extracted the two-dimensional coordinate calculator 15a and the calculated x values.

The operations of the present invention configured as described above will now be described.

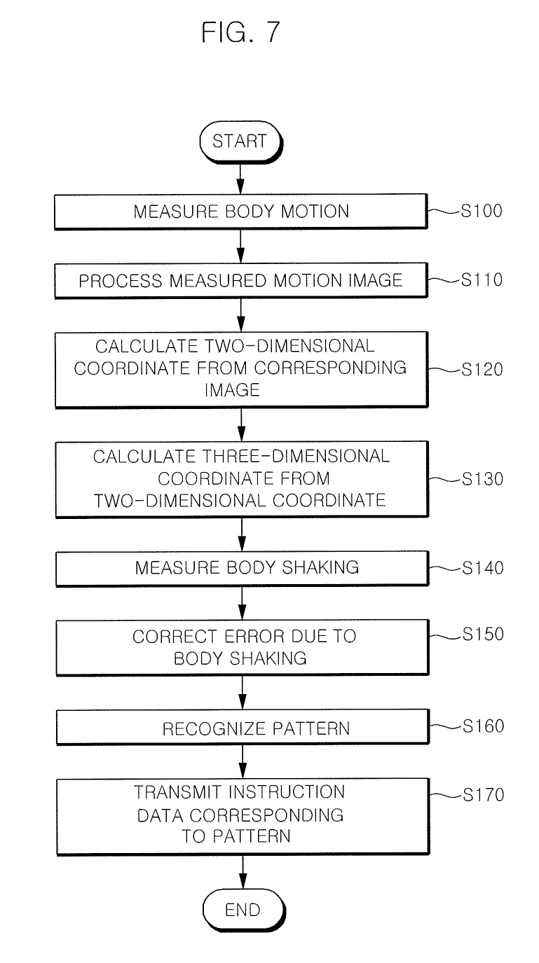

FIG. 7 is a flow chart showing an operational flow of a method for user interface based on wearable computing environment according to the present invention and shows an operation of a motion processor 10.

As shown in FIG. 7, the motion processor 10 calculates the user's body motions based on the signals from the position indicator 20 (S100). In addition, the measured motion images are processed using the image sensors of the first image measurement unit 11a and the second image measurement unit 11b of the motion processor 10 (S110).

Thereafter, the two-dimensional coordinate calculator 15a calculates the two-dimensional coordinates from the images at step ‘S110’ (S120) and the three-dimensional coordinate calculator 15b calculates the three-dimensional coordinates based on the two-dimensional coordinates at step ‘S120’ and the signals received at step ‘S100’ (S130).

Meanwhile, the body shaking measurement unit 11c calculates the degree of the body shaking from the signals received at step ‘S100’ (S140) and the body shaking corrector 15c corrects the body shaking at the corresponding images and the corresponding errors according to information measured at step ‘S140’ (S150).

The pattern recognizer 15d recognizes the motion patterns of the user from the three-dimensional coordinates calculated at step ‘S130’ and the images corrected at step ‘S150’ (S160) and extracts the instruction data corresponding to the patterns recognized at step ‘S160’ and transmits them to the wearable computer through the communication module (S170).

Although the cases where the apparatus for user interface based on wearable computing environment and the method thereof according to the present invention are applied to the wearable computer are described as the embodiments, they can be used as the interface apparatus for the wearable computer as well as for general computers.

As described above, the apparatus for user interface based on wearable computing environment and the method thereof according to the present invention is not limited to the configuration and method of the embodiments described as above, but the embodiments may be configured by selectively combining all the embodiments or some of the embodiments so that various modifications can be made.

What is claimed is:

1. An apparatus for user interface based on wearable computing environment, comprising:
a position indicator that is worn near a user's wrist to generate optical signals;
a signal measurement unit including a plurality of image measurement units that include image sensors each of which receives the optical signals generated from the position indicator and measures images of the user foreground; and
a signal processor that analyzes each image measured by the signal measurement unit to calculate three-dimensional coordinates, recognizes a motion pattern of the user's hand on the three-dimensional coordinates from the optical signals received by the signal measurement unit, and outputs the corresponding instructions.

2. The apparatus for user interface based on wearable computing environment according to claim 1, wherein the signal processor implements a virtual display screen on an area where view angles of the image sensors, which are provided in the plurality of image measurement units, are overlapped with each other and calculates the three-dimensional coordinates from the images on the virtual display screen.

3. The apparatus for user interface based on wearable computing environment according to claim 1, wherein the signal processor includes a two-dimensional coordinate calculator that extracts the two-dimensional coordinates from each image measured by the plurality of image measurement units, and
the signal processor calculates the three-dimensional coordinates based on the two-dimensional coordinates extracted by the two-dimensional coordinate calculator and the positional information of the hands sensed by the optical signals.

4. The apparatus for user interface based on wearable computing environment according to claim 1, wherein the image measurement unit includes a filter that divides the position signals generated from the positional indicator and the images.

5. The apparatus for user interface based on wearable computing environment according to claim 1, wherein the signal measurement unit includes a body shaking measurement unit that measures the body shaking from the motion of the user.

6. The apparatus for user interface based on wearable computing environment according to claim 5, wherein the body shaking measurement unit includes an inertial measurement unit.

7. The apparatus for user interface based on wearable computing environment according to claim 5, wherein the signal processor further includes a body shaking corrector that corrects the shaking of the images measured from the image measurement unit based on a degree of body shaking measured by the body shaking measurement unit.

8. The apparatus for user interface based on wearable computing environment according to claim 1, wherein the position indicator includes:
a position signal generator that generates the optical signals that indicates the position of the user's hand; and
an input signal measurement unit that receives control instructions from the user,
wherein the position indicator controls the operation of the position signal generator based on the user control instructions input to the input signal measurement unit.

9. A method for user interface based on wearable computing environment, comprising:
generating optical signals that indicates a position of a user's hand from a position indicator that is worn near a user's wrist;
receiving the optical signals generated from the position indicator and measuring a plurality of images of the user foreground;
calculating three-dimensional coordinates from by analyzing each image measured at the measuring;
grasping the positions of the user's hands from the optical signals received at the measuring and recognizing motion patterns of the user' hands on the calculated three-dimensional coordinates; and
outputting instructions corresponding to the motion patterns recognized at the recognizing.

10. The method for user interface based on wearable computing environment according to claim 9, wherein the calculating implements a virtual display screen on an area where view angles of a plurality of image sensors measuring the images at the measuring are overlapped with each other and calculates the three-dimensional coordinates from the images on the virtual display screen.

11. The method for user interface based on wearable computing environment according to claim 9, wherein the calculating includes extracting the two-dimensional coordinates from each image measured by the plurality of image measurement units, and
the calculating calculates the three-dimensional coordinates based on the extracted two-dimensional coordinates and the positional information of hands sensed by the optical signals at the measuring.

12. The method for user interface based on wearable computing environment according to claim 9, wherein the measuring includes measuring a degree of body shaking from the motion of the user.

13. The method for user interface based on wearable computing environment according to claim 12, further comprising correcting the shaking of the images measured at the measuring based on the degree of the measured body's shaking.

14. The method for user interface based on wearable computing environment according to claim 9, wherein the optical signals are generated by the position indicator each time the position of the user's hand moves.
